(19) United States
(12) Patent Application Publication
(10) Pub. No.: US 2015/0170847 A1
(43) Pub. Date: Jun. 18, 2015

(54) FORCE ACCUMULATOR FOR AN ON-LOAD TAP CHANGER

(71) Applicant: MACHINENFABRIK REINHAUSEN GMBH, Regensburg (DE)

(72) Inventor: Silke Wrede, Zeitlarn (DE)

(21) Appl. No.: 14/417,915

(22) PCT Filed: Jul. 30, 2013
(86) PCT No.: PCT/EP2013/066003

§ 371 Date: Jan. 28, 2015

(30) Foreign Application Priority Data
Jul. 28, 2012 (DE) 10 2012 107 900.5

(51) Int. Cl. H01H 3/30; H01H 9/00; H01H 3/40; F16H 33/02

(52) U.S. Cl. CPC H01H 3/3042; F16H 33/02; H01H 9/0027; H01H 3/40; H01H 2003/326

(57) ABSTRACT

The invention relates to a force accumulator for an on-load tap changer. The force accumulator has a first gear arranged on a rotatable drive shaft. The first gear drives a crank by means of at least one additional gear. The crank is mechanically connected to an elastic element, which can be tensioned when a drive element is heated up. An output element can be triggered after the elastic element has been tensioned and swivels abruptly. The drive element is a rocker. The rocker has a first rocker roller and a second rocker roller, which alternately actuate a first pawl and a second pawl. A first detent position and a second detent position are associated with the first pawl on the output element and likewise a first detent position and a second detent position are associated with the second pawl on the output element, such that the first pawl and the second pawl are alternately in the first detent position and in the second detent position, in dependence on the position of the rocker.

The present invention relates to a force accumulator for an on-load tap changer. The force accumulator comprises a first gear that is provided at a rotatable drive shaft and that drives a crank by way of at least one further gear. The crank is in mechanical connection with a resilient element that can be loaded when the drive element is drawn up. A drive output element can be triggered after loading of the resilient element and pivots abruptly.

On-load tap changers of the kind stated in the introduction are widely known and conventional in the art. They serve for uninterrupted switching between different winding taps of tapped transformers. Since this switching process usually takes place abruptly, on-load tap changers usually have a force is accumulator.

Force accumulators known from the prior art are, at the start of each actuation of the on-load tap changer, drawn up by the continuously rotating drive shaft thereof, i.e. loaded. The known force accumulators, such as disclosed in, for example, German published specification DE 19 56 369 and German patent specification DE 28 06 282 [GB 2 014 794], essentially consist of a draw-up carriage and a jump carriage, between which springs as force accumulator are provided. In addition, guide rods are provided, on which the draw-up carriage and also the jump carriage are mounted to be longitudinally movable independently of one another. At the same time, the guide rods form the guide for the springs in such a manner that each spring surrounds a respective guide rod. The draw-up carriage is linearly moved toward the jump carriage in relative terms by an eccentric connected with the drive shaft, whereby the springs provided therebetween are loaded. When the draw-up carriage has reached its end position, locking of the jump carriage is triggered.

High and very high demands are on accuracy are represented by, in particular, the longitudinal guidance at both sides of the longitudinally displaceable draw-up carriage and jump carriage by means of parallel disposed guide rods. Moreover, in the case of these force accumulators there is a double conversion of the movement direction. A rotational movement of the drive shaft is converted into a longitudinal movement of the force accumulator, the longitudinal movement of which after release is in turn converted back into a rotational movement of the switch shaft for actuation of the tap changer. This is complicated, inappropriate and superfluous for tap changers or the load switches thereof that are already linearly movable. Moreover, these force accumulators have numerous points of friction that promote mechanical faults and increase production costs.

Consequently, force accumulators are already known that convert a continuous rotational movement of a drive shaft into an abrupt, rapid pivot movement of a drive output shaft so that sliding friction no longer occurs and resistance is low. This is described in, for example, German patent specifications DE 10 2006 008 338 [U.S. Pat. No. 8,119,939], DE 10 2009 034 627 [U.S. Pat. No. 8,748,758] and DE 10 2010 046 280 B3. The abrupt rotational movement of the drive output shaft is made possible by the fact that one or more loaded springs are abruptly released. Such springs can be not only tension springs, but also compression springs. In that case the principle remains the same. A rotating drive shaft loads the spring or springs up to a maximum point, after which these abruptly relax and thereby move the drive output shaft at the same time. Force accumulators of this kind are known in the most diverse forms of embodiment and are distinguished by the fact that they dispense with the complicated technical conversion of an initial straight-line draw-up movement into a rapid rotational main movement that is necessary for the actual load switching, for actuation of the switching contacts.

In addition, a force accumulator for an on-load tap changer according to the introductory part of the present claim 1 is disclosed in Chinese Utility Model specification CN 201845670 U, wherein here numerous individual components are provided between an is upper and a lower mounting plate or mounted on these.

It is disadvantageous with this prior art that the force accumulator is constructed from numerous individual components that on the one hand substantially complicate construction and on the other hand demand a large amount of constructional space at an on-load tap changer. Due to the numerous components, exchange of components in the case of a mechanical fault is very work-intensive and costly.

The invention has the object of creating a space-saving and simple force accumulator for an on-load tap changer that involves low production and maintenance costs and keeps down energy losses and energy consumption.

This object is fulfilled by a force accumulator for an on-load tap changer that comprises the features of claim 1.

The force accumulator according to the invention for an on-load tap changer comprises a first gear that is provided at a rotatable drive shaft and that drives a crank by way of at least one further gear. In that case, the force accumulator is centrally driven by the drive shaft for each switching process. It is obvious to an expert that an eccentric drive is also conceivable instead of a central drive for the drive shaft. In that case, the rotatable drive shaft, which is at the same time also the drive of the selector, is driven by a motor (with transmission) that provides 180 or 360 degrees. However, it is also conceivable for the drive shaft to be directly driven by a step motor. Advantageously, here the drive shaft can be rotated in each switching step through 180 degrees so that the first gear provided at the drive shaft is similarly driven for this switching step.

Since it is generally known that gears transmit a mechanically positive and slip-free force transfer with alternating rotational direction, in a preferred embodiment a further gear is provided between the first gear and the gear driving the crank, so that the crank has the same direction of rotation as the drive shaft.

In that case, the crank is mechanically connected with a resilient element that is loaded when a drive element is drawn up. After loading of the resilient element a drive output element can be triggered and pivots abruptly.

According to the invention the drive element is a rocker.

The rocker in that case comprises a first rocker roller and a second rocker roller that in alternation respectively actuate a first latch and a second latch. In that regard, a first detent position and a second detent position are associated with the first latch at the drive output element. Equally, a first detent position and a second detent position are associated with the second latch at the drive output element. Thus, the first latch and the second latch are disposed in alternation in the first detent position and the second detent position depending on the setting of the rocker.

In order to bring the two latches into the first or into the second detent position, the first latch comprises a first latch roller and the second latch a second latch roller. It is also to be noted that through the construction of the first latch roller and the second latch roller and their associated first detent positions and second detent positions the drive output element is secured against turning.

Moreover, provision is made for the first latch to be constructed to be pivotable about a first latch bearing and the second latch to be pivotable about a second latch bearing.

Equally, the force accumulator according to the invention provides that a coupler mechanically couples the crank and the rocker. For that purpose, the crank driven by the drive shaft transmits a rotational movement to the coupler by way of the mechanical coupling so that the coupler driven with a rotational movement enables, through the mechanical connection with the rocker, pivoting of the rocker. By virtue of the pivoting of the rocker on the one hand the resilient element is loaded and also, for example, the first rocker roller is pressed against the first latch and thus the first latch rotated about the first latch bearing. The first latch roller is also thereby moved out of its first detent positions, which in turn means that the fixing of the drive output shaft is cancelled. After this switching process, the first latch roller thus changes from the first detent position to the second detent position, wherein in that case at the same time the second latch roller changes from the second detent position to the first detent position. When the first latch roller and the second latch roller have again reached a first detent position or second detent position, respectively, the force accumulator according to the invention is again in an end setting and the load switch setting fixed.

The resilient element is preferably a spring. In a preferred form of embodiment the spring is then constructed as a torsion spring, wherein, however, also any other spring known in the prior art is conceivable. For that purpose, the torsion spring has two legs that co-operate alternately with a spring abutment of the drive output element and a spring abutment of the rocker. In particular, the force accumulator is designed in such a manner that in the case of pivoting of the rocker a first leg of the torsion spring is fixed by the spring abutment of the drive output element and a second leg of the torsion spring is entrained, so that the torsion spring is thereby loaded.

In particular, the force accumulator according to the invention also provides a latch tension spring that mechanically couples the first latch and the second latch and biases the first latch and the second latch against an external profile of the drive output element, so that the first and second latch rollers can be brought by way of the latch tension spring into the first detent position or the second detent position of the drive output element and urged into this position. The outer profile of the drive output element is formed as a curve or cam for the first and second latch rollers.

The drive output element described in the previous forms of embodiment is, especially, a load switch drive wheel. A more detailed description and illustration of the drive output element as load switch drive wheel is dispensed with, since diverse mechanical components known and conventional in the prior art can be used for that purpose. Thus, it will be obvious to the expert that the load switch drive wheel can, for example, consist of a drilled workpiece into which further components such as, for example, roller bearings are let.

An advantage of the force accumulator according to the invention for an on-load tap changer consists in the fact that due to the overall construction and the few components incorporated in the force accumulator a space-saving and simple force accumulator is created. In addition, by virtue of the arrangement of the torsion spring the force accumulator is accompanied by a further advantage that, in particular, the force accumulator can be used for switching actions in alternating direction of rotation or pivoting and thus independently of the drive direction, whereagainst radial, friction-reduced and thus loss-reduced force accumulators, which are known in the prior art, for an on-load tap changer are directionally dependent. The force accumulator according to the invention is also low in its production and maintenance costs due to the, in general, few incorporated components.

A further advantage of the force accumulator according to the invention is that through the use of roller bearings, as already described above for the drive output element, the energy losses caused by friction are kept low.

The invention and its advantages are described in more detail in the following with reference to the accompanying drawings, in which:

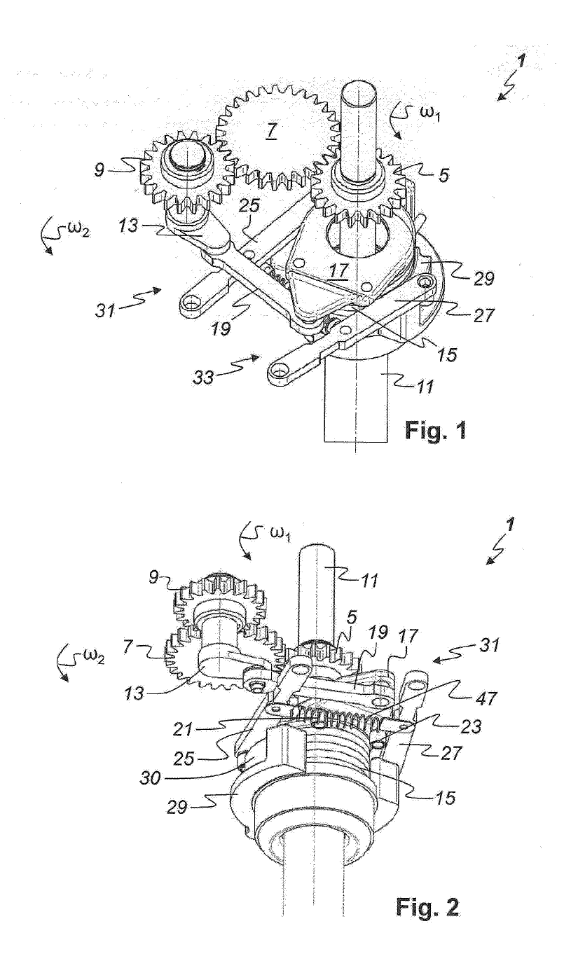

FIG. 1 shows a perspective view of the force accumulator according to the invention from above;

FIG. 2 shows a perspective view of the force accumulator shown in FIG. 1, from below;

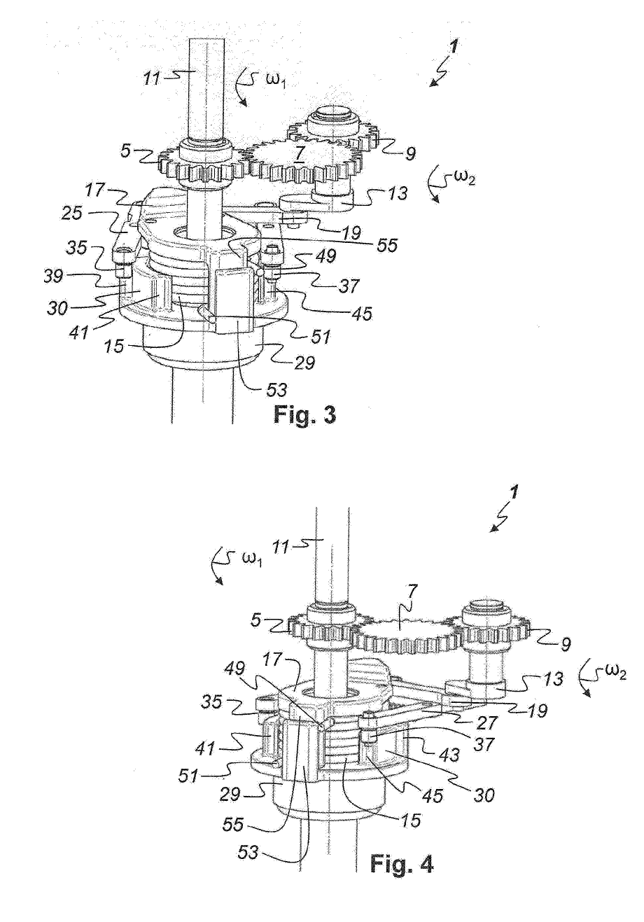

FIG. 3 shows a perspective view of the force accumulator, wherein the first latch is disposed in a first detent position and the second latch in a second detent position at the drive output element;

FIG. 4 shows a perspective view of the force accumulator according to FIG. 3;

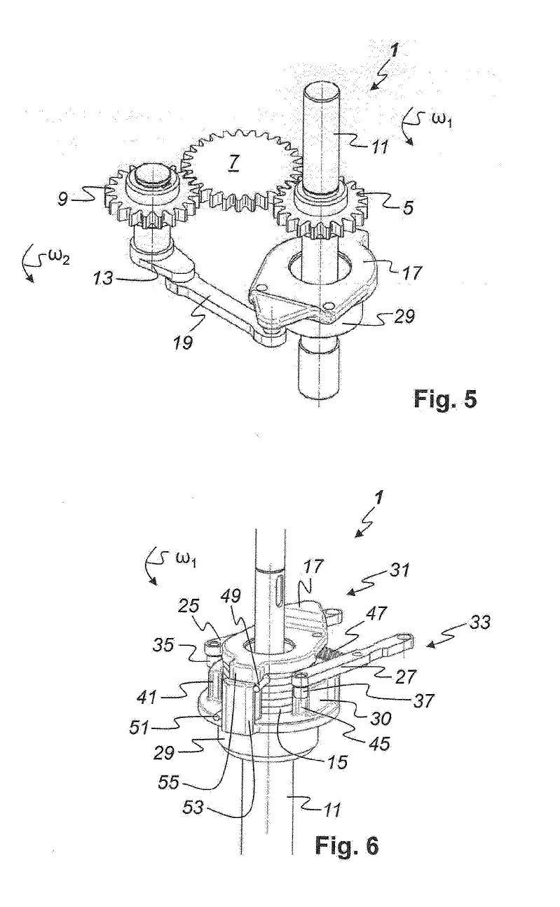

FIG. 5 shows a further perspective view of the force accumulator, wherein the first latch, the second latch and the latch tension spring for mechanical coupling of the two latches are not shown;

FIG. 6 shows a further perspective view of the force accumulator, wherein for the sake of clarity the gears, crank and coupler are not illustrated;

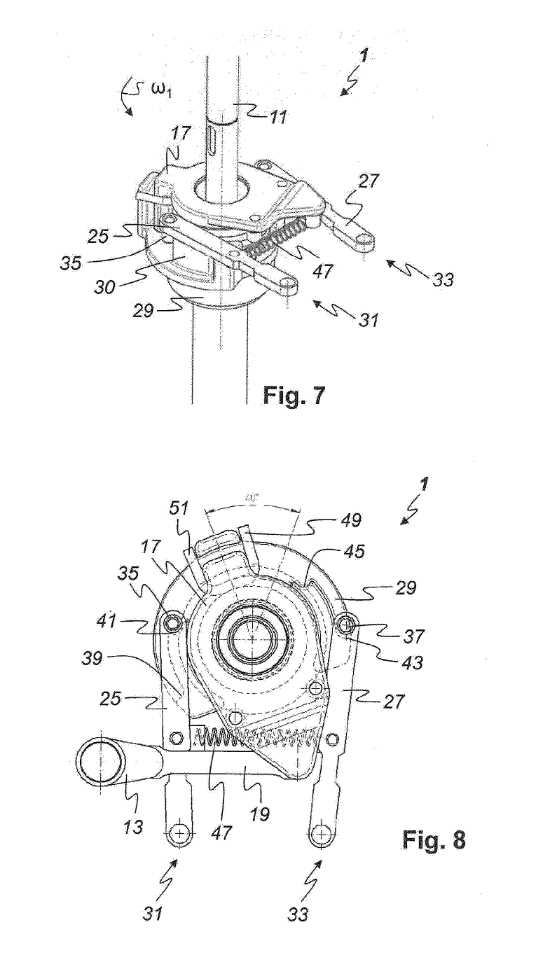

FIG. 7 shows a perspective of the force accumulator according to FIG. 6, from above; and

FIG. 8 shows a plan view of the force accumulator.

Identical reference numerals are used in the FIGS. for the same or equivalent elements of the invention. Moreover, for the sake of clarity only reference numerals required for description of the respective FIG. are illustrated in the individual figures.

FIG. 1 shows a perspective view, from above, of the force accumulator 1 according to the invention for an on-load tap changer. The force accumulator 1 here comprises a first gear 5 that is provided on a rotatable drive shaft 11 and that drives a crank 13 by way of a third gear 9. Provided between the first gear 5 and the second gear 9 is a second gear 7 so that a rotational angle w₂ of the crank 13 is the same as a rotational angle ω₁ of the drive shaft 11. It will be obvious to the expert that the force accumulator 1 according to the invention can also provide more or less than three gears 5, 7, 9 in other forms of embodiment.

Since the crank 13 is mechanically connected with a resilient element 15, the resilient element 15 can be loaded when a drive element 17 is drawn up. After loading of the resilient element 15, a drive output element 29 can be triggered and pivots abruptly.

According to the invention the drive element is a rocker 17. The rocker 17 can preferably comprise roller bearings (not visible) that have been embedded, so that low energy losses due to friction arise.

As shown in FIG. 2, the rocker 17 comprises a first rocker roller 21 and a second rocker roller 23 that respectively actuate in alternation a first latch 25 and a second latch 27, wherein the first latch 25 is constructed to be pivotable about a first latch bearing 31 and the second latch 27 about a second latch bearing 33.

In that case, according to the invention, in addition—as shown in the further perspective views of the force accumulator 1 according to FIGS. 3 and 4—a first detent position 39 and a second detent position 41 are associated with the first latch 25 at the drive output element 29 and a first detent position 43 and a second detent position 45 are similarly associated with the second latch 27 at the drive output element 29. Thus, the first latch 25 and the second latch 27 are alternately disposed in the first detent position 39, 43 and the second detent position 41, 45 depending on the setting of the rocker 17.

As equally shown in FIGS. 3 and 4, the first latch 25 comprises a first latch roller 35 and the second latch 27 a second latch roller 37, by which the two latches 25, 27 can be brought into the first detent positions 39, 43 or the second detent positions 39, 43 so that through the construction of the first latch roller 35 and the second latch roller 37 and the first detent positions 39, 43 and second detent positions 39, 43 associated therewith the drive element 29 is secured against turning.

At this point reference is again made to FIG. 2, since here the force accumulator 1 according to the invention has a latch tension spring 47. This latch tension spring 47 is provided for the purpose of, in particular, mechanically coupling the first latch 25 and the second latch 27 and biasing the first latch 25 and the second latch 27 against an external profile 30, such as here against a curve, of the drive output element 29, so that the first latch roller 35 and the second latch roller 37 can be brought by way of the latch tension spring 47 into the first detent position 39, 43 or second detent position 41, 45 of the drive output element 29 or urged thereinto.

Moreover, the force accumulator 1 according to the invention provides, as shown in all of FIGS. 1 to 4, that a coupler 19 mechanically couples the crank 13 and the rocker 17 and the resilient element is preferably a spring 15. The spring 15 is in that case constructed, as equally shown in all previously described FIGS. 1 to 4, as a torsion spring. For that purpose, the torsion spring 15 has two legs 49, 51 that co-operate alternately with a spring abutment 53 of the drive output element 29 and a spring abutment 55 of the rocker 17. In particular, the force accumulator 1 is designed in such a manner that in the case of pivoting of the rocker 17 a first leg 51 of the torsion spring 15 is fixed by the spring abutment 53 of the drive output element 29 and a second leg 55 of the torsion spring 15 is entrained, so that the torsion spring 15 can thereby be loaded.

The drive output element 29 is preferably a load switch drive wheel. A more detailed description and illustration of the drive output element 29 as load switch drive wheel is, for reasons of clarity, dispensed with, since these are known and conventional everywhere in the prior art.

The mode of functioning of the force accumulator 1 according to the invention is briefly explained by way of the already described features with respect to FIGS. 1 to 4. The crank 13 driven by the drive shaft 11 transmits, by way of the mechanical coupling, a rotational movement to the coupler 19 so that the coupler 19 driven with a rotational movement enables, through the mechanical connection with the rocker 17, pivoting of the rocker 17. Through the pivoting of the rocker 17 on the one hand the spring 15 is biased and also, for example, the first rocker roller 21 urged against the first latch 25 and thus the first latch 25 rotated about the first latch bearing 31. As a result, the first latch roller 35 is also moved out of its first detent position 39 that in turn means that the fixing of the drive output element 29 is cancelled. After this switching process the first latch roller 35 thus changes from the first detent position 39 to the second detent position 41 (see with respect thereto FIGS. 3 and 4), wherein in that case at the same time the second latch roller 37 changes from the second detent position 45 to the first detent position 43 (see, similarly, with respect thereto FIGS. 3 and 4). When the first latch roller 35 and the second latch roller 37 have again reached a first detent position 39, 43 or second detent position 41, 45, respectively, the force accumulator 1 according to the invention is again in an end setting and the load switch setting is fixed.

Since all features have already been described in FIGS. 1 to 4 and the further FIGS. 5 to 8 merely show further perspective views according to FIGS. 1 to 4, a further description of FIGS. is dispensed with at this point.

The invention was described with reference to preferred forms of embodiment. However, it will be obvious to any expert that modifications and changes can be undertaken without in that case departing from the scope of protection of the appended claims. The embodiments explained in the preceding serve merely for description of the claimed teaching, but do not restrict this to the embodiments.

### REFERENCE NUMERAL LIST

1 force accumulator
5 first gear
7, 9 further gear
11 drive shaft
13 crank
15 resilient element, spring
17 drive element, rocker
19 coupler
21 first rocker roller
23 second rocker roller
25 first latch
27 second latch
29 drive output element
30 external profile
31 first latch bearing
33 second latch bearing
35 first latch roller
37 second latch roller
39 first detent position of the first latch
41 second detent position of the first latch
43 first detent position of the second latch
45 second detent position of the second latch
47 latch tension spring
49 first leg
51 second leg
53 spring abutment of the drive output element
55 spring abutment of the rocker
ω₁ rotational angle of the drive shaft
ω₂ rotational angle of the crank

1. A force accumulator for an on-load tap changer, with a first gear that is provided on a rotatable drive shaft and that drives a crank by way of at least one further gear, wherein the crank is mechanically connected with a resilient element that can be loaded when the drive element is drawn up and wherein a drive output element after loading of the resilient element can be triggered and abruptly pivots,
wherein
the drive element is a rocker that comprises a first rocker roller and a second rocker roller respectively actuating in alternation a first latch and a second latch,
a first detent position and a second detent position are associated with the first latch at the drive output element, and
a first detent position and a second detent position are associated with the second latch at the drive output element so that the first latch and the second latch are disposed in alternation in the first detent position and the second detent position in dependence on the setting of the rocker.

2. The force accumulator according to claim 1, wherein the first latch comprises a first latch roller and the second latch comprises a second latch roller, by which the two latches can be brought into the first detent positions or into the second detent positions.

3. The force accumulator according to claim 1, wherein the first latch is pivotable about a first latch bearing and the second latch is pivotable about a second latch bearing.

4. The force accumulator according to claim 1, further comprising:
a coupler that mechanically couples the crank and the rocker.

5. The force accumulator according to claim 1, wherein the resilient element is a spring that is constructed as a torsion spring.

6. The force accumulator according to claim 5, wherein the spring has two legs that co-operate in alternation with a spring abutment of the drive output element and a spring abutment of the rocker.

7. The force accumulator according to claim 1, further comprising:
a latch tension spring that mechanically couples the first latch and the second latch and biases the first latch and the second latch against an external profile of the drive output element.

8. The force accumulator according to claim 1, wherein the drive output element is a load switch drive wheel.
